(19) United States
(12) Patent Application Publication
(10) Pub. No.: US 2025/0382415 A1
(43) Pub. Date: Dec. 18, 2025

(54) POLYAMIDE RESIN, POLYAMIDE RESIN COMPOSITION, MOLDED BODY AND METHOD FOR PRODUCING POLYAMIDE RESIN

(71) Applicant: Kureha Corporation, Tokyo (JP)

(72) Inventors: Takashi MASAKI, Tokyo (JP); Fuminori KOBAYASHI, Tokyo (JP); Haruki MOKUDAI, Tokyo (JP)

(73) Assignee: Kureha Corporation, Tokyo (JP)

(21) Appl. No.: 19/108,021

(22) PCT Filed: Sep. 29, 2023
(86) PCT No.: PCT/JP2023/035711

§ 371 Date: Feb. 28, 2025

(30) Foreign Application Priority Data
Sep. 30, 2022 (JP) 2022-158909
Apr. 28, 2023 (JP) 2023-074569

(51) Int. Cl. C08G 69/24; C08G 69/20; D01F 6/60

(52) U.S. Cl. CPC C08G 69/24; C08G 69/20; D01F 6/60; D10B 2331/02

(57) ABSTRACT

Provided is a polyamide resin, which is a copolymer of a biodegradable polyamide, such as polyamide 2 to polyamide 4, and another polyamide, the polyamide resin having enhanced biodegradability. The polyamide resin contains a structural unit represented by Formula (1) and another polyamide structural unit, and a difference between a degree of randomness determined based on a proportion of each structural unit as determined by ¹H-NMR measurement when structural units are assumed to have an ideal random sequence and a degree of randomness determined based on a proportion of carbonyl carbon of an amide group linking different structural units with respect to a total peak integrated value for carbonyl carbon as determined by ¹³C-NMR measurement is 0.10 or less, where in Formula (1), x is an integer of 1 or greater and 3 or less.

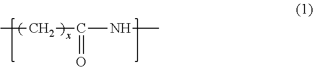

### TECHNICAL FIELD

The present invention relates to a polyamide resin, a polyamide resin composition, a molded body, and a method for producing a polyamide resin.

### BACKGROUND ART

Polyamide 4 is characterized by high heat resistance due to its high melting point, high mechanical strength, and low environmental impact because the polyamide 4 can be synthesized from a biomass-derived raw material (2-pyrrolidone) and also the polyamide 4 itself has biodegradability.

Non-Patent Document 1 describes that mechanical properties and thermal properties of polyamide 4 are modified by introduction of an initiator-derived specific structure and an ε-caprolactam-derived structure into the polyamide 4. Non-Patent Document 1 describes that this copolymer is slightly biodegraded. However, Non-Patent Document 1 describes that, in a case where 40 mol % or less of the polyamide 4-derived structure was included, biodegradation almost did not occur.

### CITATION LIST

### Non-Patent Literature

Non-Patent Document 1: Kawasaki, Journal of Applied Polymer Science, 2020, Volume 137, Issue 39, 49165

### SUMMARY OF INVENTION

### Technical Problem

Polyamide 4 has issues that molding is difficult because thermal decomposition tends to occur during melt molding due to the melting point and the thermal decomposition temperature being close. Meanwhile, improvement in moldability can be expected by lowering the melting point of PA4 as a copolymer with other polyamides as described in Non-Patent Document 1.

Non-Patent Document 1 describes that a copolymer of 2-pyrrolidone and ε-caprolactam synthesized in this document exhibited biodegradability. Taking the fact that polyamide 4 synthesized from 2-pyrrolidone is easily biodegraded and polyamide 6 synthesized from ε-caprolactam is difficult to be biodegraded into consideration, the biodegradability of the copolymer described above is assumed to be provided by the 2-pyrrolidone derived-structural unit. Note that similar biodegradability can be expected for a copolymer of glycine (copolymer of polyamide 2) or a copolymer of α-alanine (2-aminopropanoic acid) or β-alanine (3-aminopropanoic acid) or β-lactam (2-azetidinone) (copolymer of polyamide 3) due to the protein-like structures included in these.

However, the copolymer described in Non-Patent Document 1 only exhibits slight biodegradability. Specifically, the biodegradability described in the results of experiment described in Non-Patent Document 1 is less than the content of the structural unit derived from 2-pyrrolidone and, in a case where the amount of the 2-pyrrolidone-derived structure is 40 mol % or less, almost no biodegradation occurs. Since the undegraded portion is concerned to be microplastics, higher biodegradability is desired to reduce environmental pollution due to waste plastics.

The present invention has been completed in light of the issues described above, and an object of the present invention is to provide a polyamide resin, which is a copolymer of a biodegradable polyamide, such as polyamide 2 to polyamide 4, and another polyamide and that has enhanced biodegradability, a polyamide resin composition containing the polyamide resin, a molded body obtained by the polyamide resin composition, and a method for producing the polyamide resin.

### Solution to Problem

Embodiments of the present invention to solve the issues described above relate to polyamide resins of [1] to [4] described below.

[1] A polyamide resin, including: a first monomer structural unit represented by Formula (1) and a second monomer structural unit constituting another polyamide structure, wherein
a difference between a degree of randomness that is determined based on proportions of the first monomer structural unit and the second monomer structural unit determined by ¹H-NMR measurement when the first monomer structural unit is assumed to have an ideal random sequence and a degree of randomness that is determined based on a proportion of carbonyl carbon of an amide group linking the first monomer structural unit and the second monomer structural unit with respect to a total peak integrated value for carbonyl carbon determined by ¹³C-NMR measurement is 0.10 or less.

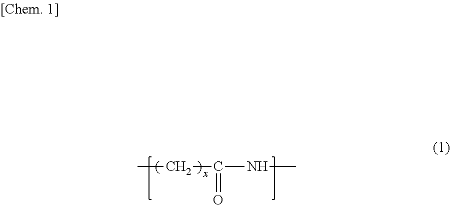

where in Formula (1), x is an integer of 1 or greater and 3 or less.
   [2] The polyamide resin according to [1], wherein a proportion of the first monomer structural unit represented by Formula (1) with respect to all structural units is 1 mol % or greater and less than 40 mol %.
   [3] The polyamide resin according to [1] or [2], wherein the first monomer structural unit represented by Formula (1) includes a structural unit where x is 3.
   [4] The polyamide resin according to any of [1] to [3], wherein the other polyamide structural unit includes a polyamide 6 structural unit.

Another embodiment of the present invention to solve the issues described above relates to a polyamide resin composition of [5] described below.

[5] A polyamide resin composition containing the polyamide resin described in any one of [1] to [4].

Other embodiments of the present invention to solve the issues described above relate to polyamide resin compositions of [6] and [7] described below.

[6] A molded body obtained by molding the polyamide resin composition described in [5].
[7] The molded body according to [6], which is a filament.

Other embodiments of the present invention to solve the issues described above relate to methods for producing polyamide resins of [8] and [9] described below.

[8] A method for producing a polyamide resin, the method including: preparing, by polymerization, a first monomer constituting a structural unit represented by Formula (1) and a second monomer constituting another polyamide structural unit, and
polymerizing the first monomer and the second monomer in the presence of a Grignard reagent, which is a basic catalyst, and a polymerization initiator.
   [9] The method for producing a polyamide resin according to [8], wherein the polymerizing is performed at 50° C. or higher.

### Advantageous Effects of Invention

According to embodiments of the present invention, a polyamide resin which is a copolymer of a biodegradable polyamide, such as polyamide 2 to polyamide 4, and another polyamide and that has enhanced biodegradability, a polyamide resin composition containing the polyamide resin, a molded body obtained by the polyamide resin composition, and a method for producing the polyamide resin are provided.

### DESCRIPTION OF EMBODIMENTS

### Polyamide Resin and Production Method Thereof

An embodiment of the present invention relates to a polyamide resin.

The polyamide resin described above contains a first monomer structural unit represented by the following Formula (1) and a second monomer structural unit constituting another polyamide structure.

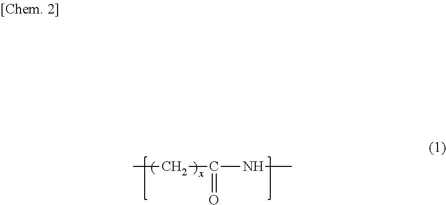

In Formula (1), x is an integer of 1 or greater and 3 or less. Note that, when x is 2 or 3, the alkylene group in Formula (1) may be linear or branched.

The structural unit represented by Formula (1) may include only structural units having the same number for x or may include a plurality of types of structural units having different numbers for x.

In the polyamide resin related to the present embodiment, first monomer structural units are randomly introduced. In other words, the polyamide resin related to the present embodiment has a low proportion of blocks in which only the same first monomer structural units are continuously present and has a high proportion of blocks in which a first monomer structural unit and a second monomer structural unit are connected side by side. According to the knowledge of the inventors of the present invention, the polyamide resin described above has higher biodegradability when first monomer structural units are randomly introduced. Thus, the polyamide resin described above is characterized by having high biodegradability. Note that, as described in Examples below, the polyamide resin described above can generate more carbon dioxide than the theoretical amount when all the first monomer structural units represented by Formula (1) has been decomposed by biodegradation. This fact indicates that in the polyamide resin related to the present embodiment, not only the first monomer structural unit represented by Formula (1), but also the second monomer structural unit that is the other polyamide structural unit are decomposed.

From the viewpoints described above, the polyamide resin described above has a difference between a degree of randomness (hereinafter, also referred to as “difference Δ between degrees of randomness”) that is determined the difference between theoretical degree of randomness based on a proportion of each of the structural units determined by ¹H-NMR measurement when the first monomer structural unit is assumed to have an ideal random sequence (hereinafter, also referred to as “theoretical degree of ¹H randomness”) and an actually measured degree of randomness that is determined based on a proportion of carbonyl carbons of amide groups linking the first monomer structural unit and the second monomer structural unit with respect to total peak integrated values for carbonyl carbons determined by ¹³C-NMR measurement (hereinafter, also referred to as “degree of ¹³C randomness”) is preferably 0.10 or less, and more preferably 0.05 or less. The lower limit value of the difference Δ between degrees of randomness is not particularly limited and can be 0.00 or greater.

Note that degree of ¹³C randomness is a value calculated based on the following Expression 1.

$$( sum of peak integrated values originated from carbonyl carbon peaks of amide groups connected to the first monomer structural unit and the second monomer structural unit ) \text{} / ( sum of peak integrated values originated from all carbonyl carbon peaks ) \qquad Expression 1$$

The theoretical degree of ¹H randomness is a proportion of carbonyl carbons of amide groups linking different structural units with respect to a total number of carbonyl carbons when all structural units are stochastically and randomly sampled and arranged in the polyamide resin described above and is calculated by the following Expression 2 based on the proportion of each structural unit determined by ¹H-NMR measurement.

$$( existing ratio of first monomer structural unit ) \times ( existing ratio of second monomer structural unit ) \times 2 \qquad Expression 2$$

The difference Δ between degrees of randomness can be adjusted by catalyst type, polymerization temperature, and the like. For example, by using a Grignard reagent which enhances the reactivity of a monomer as a catalyst, a difference between reactivities of monomers can be made small, and thus the difference Δ between degrees of randomness can be made small. Furthermore, when the polymerization temperature is a high temperature, the monomer that becomes the second monomer structural unit is preferentially consumed, or when the polymerization temperature is a low temperature, the monomer that becomes the first monomer structural unit represented by Formula (1) is preferentially consumed, and thus a block in which only the first monomer structural units are continuously present tends to be formed. Thus, by setting the polymerization temperature to an adequate range based on the combination of the monomers, the difference between reactivities of monomers is made small, and the difference Δ between degrees of randomness can be made small.

Note that a higher proportion of the first monomer structural unit represented by Formula (1) in the polyamide resin tends to enhance biodegradability. Meanwhile, a higher proportion of the second monomer structural unit in the polyamide resin can enhance thermal stability during melt processing of the polyamide resin. From the viewpoint of achieving a good balance of these, the polyamide resin described above has a proportion of the first monomer structural unit represented by Formula (1) with respect to all the structural units of preferably 1 mol % or greater and less than 90 mol %, more preferably 1 mol % or greater and less than 60 mol %, even more preferably 1 mol % or greater and less than 40 mol %, even more preferably 3 mol % or greater and 30 mol % or less, even more preferably 5 mol % or greater and 17 mol % or less, and particularly preferably 5 mol % or greater and 14 mol % or less.

Furthermore, from the same viewpoint, the polyamide resin described above has a proportion of the second monomer structural unit constituting the other polyamide structural unit with respect to all the structural units of preferably greater than 10 mol % and 99 mol % or less, more preferably greater than 40 mol % and 99 mol % or less, even more preferably greater than 60 mol % and 99 mol % or less, even more preferably 70 mol % or greater and 97 mol % or less, even more preferably 83 mol % or greater and 95 mol % or less, and particularly preferably 86 mol % or greater and 95 mol % or less.

The first monomer structural unit represented by Formula (1) may be a structural unit having x=1 and derived from glycine (hereinafter, also referred to as “PA 2 structural unit”), may be a structural unit having x=2 and derived from α-alanine (2-aminopropanoic acid), β-alanine (3-aminopropanoic acid), or β-lactam (2-azetidinone) (hereinafter, also referred to as “PA 3 structural unit”), or may be a structural unit having x=3 and derived from 2-pyrrolidone (hereinafter, also referred to as “PA 4 structural unit”).

The second monomer structural unit constituting the other polyamide structure may be a structural unit represented by Formula (2) made by ring-opening polymerization of a lactam compound or polymerization of amino acid, or may be a structural unit represented by Formula (3) and a structural unit represented by Formula (4) respectively derived from the diamine described above and the dicarboxylic acid described above when the moieties formed by condensation of a polyamine and a polycarboxylic acid are contained in the polyamide resin described above. The structural unit of the other polyamide may contain only one of these or may contain a plurality of these.

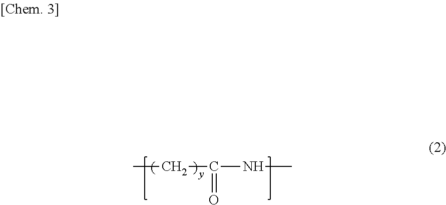

In Formula (2), y is an integer of 4 or greater and 11 or less. Note that the alkylene group in Formula (2) may be linear or branched.

When the structural unit represented by Formula (2) is contained, the second monomer structural unit constituting the other polyamide structure may include only structural units having the same number for y or may include a plurality of types of structural units having different numbers for y.

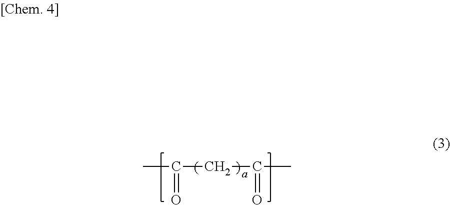

In Formula (3), a is an integer of 1 or greater and 10 or less. Note that the alkylene group in Formula (3) may be linear or branched.

When the structural unit represented by Formula (3) is contained, the second monomer structural unit may include only structural units having the same number for a or may include a plurality of types of structural units having different numbers for a.

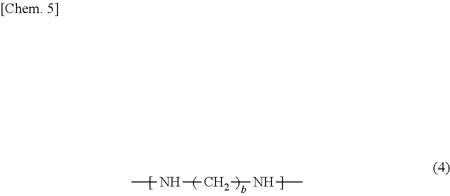

In Formula (4), b is an integer of 1 or greater and 12 or less. Note that the alkylene group in Formula (4) may be linear or branched.

When the second monomer structural unit contains the structural unit represented by Formula (4), the second monomer structural unit may include only structural units having the same number for b or may include a plurality of types of structural units having different numbers for b.

From the viewpoint of further enhancing biodegradability, the second monomer structural unit constituting the other polyamide structure is a structural unit represented by Formula (2), and preferably includes a structural unit, in which y is 4 or greater and 7 or less, and more preferably includes a structural unit, in which y is 5, (hereinafter, also referred to as “PA 6 structural unit”), and even more preferably, the first monomer structural unit is a PA 4 structural unit having x=3 and the second monomer structural unit is a PA 6 structural unit having y=5. The proportion of the PA 6 structural unit with respect to the second monomer structural unit constituting the other polyamide structure is preferably 50 mol % or greater and 100 mol % or less, more preferably 70 mol % or greater and 100 mol % or less, and even more preferably 85 mol % or greater and 100 mol % or less.

Alternatively, from the viewpoint of enhancing water resistance of a molded body, the second monomer structural unit constituting the other polyamide structure preferably includes a structural unit, in which y is 5 or greater and 11 or less, and more preferably includes a structural unit, in which y is 11, (hereinafter, also referred to as “PA 12 structural unit”), and even more preferably, the first monomer structural unit is a PA 4 structural unit having x=3 and the second monomer structural unit is a PA 12 structural unit having y=11. The proportion of the PA 12 structural unit with respect to the second monomer structural unit constituting the other polyamide structure is preferably 50 mol % or greater and 100 mol % or less, more preferably 70 mol % or greater and 100 mol % or less, and even more preferably 85 mol % or greater and 100 mol % or less. Alternatively, from the viewpoint of providing water resistance and heat resistance of a molded body in a compatible manner, the proportion of the PA 12 structural unit with respect to the second monomer structural unit constituting the other polyamide structure is preferably 1 mol % or greater and 50 mol % or less, more preferably 1 mol % or greater and 30 mol % or less, and even more preferably 1 mol % or greater and 15 mol % or less.

The structural units derived from the diamine described above and the dicarboxylic acid described above can be respectively, for example, structural units derived from the following diamine and the following dicarboxylic acid when the polyamide resin described above contains a moiety formed by condensation of a diamine, such as hexamethylenediamine, nonanediamine, methylpentadiamine, m-xylylenediamine, p-phenylenediamine, and m-phenylenediamine, and a dicarboxylic acid, such as adipic acid, sebacic acid, terephthalic acid, and isophthalic acid. From the viewpoint of enhancing heat resistance of a molded body, the polyamide resin described above has a proportion of the structural units derived from the diamine described above and the dicarboxylic acid described above with respect to all the structural units of preferably 50 mol % or greater and 100 mol % or less, more preferably 70 mol % or greater and 100 mol % or less, and even more preferably 85 mol % or greater and 100 mol % or less.

The polyamide resin described above may be a copolymer consisting only of the first monomer structural unit represented by Formula (1) and the second monomer structural unit constituting the other polyamide structure or may be a copolymer further containing another structural unit. Examples of such another structural unit described above include a structural unit derived from a polymerization initiator and a structural unit other than polyamide. From the viewpoint of enhancing biodegradability, the polyamide resin described above has a proportion of such another structural unit described above with respect to all the structural units of preferably 0 mol % or greater and 50 mol % or less, more preferably 0 mol % or greater and 30 mol % or less, and even more preferably 0 mol % or greater and 15 mol % or less.

Note that the second monomer structural unit can reduce heat-decomposability of the polyamide resin described above. Thus, the polyamide resin described above that is a copolymer with the second monomer structural unit can suppress contamination by a monomer generated by decomposition during melt processing (especially, a monomer that becomes as a raw material for the first monomer structural unit represented by Formula (1)). Thus, the polyamide resin described above can suppress environmental pollution due to elution of a decomposed monomer from a molded body.

The type and the proportion of each of the structural units contained in the polyamide resin described above can be calculated based on an integrated value of a peak assigned to each structural unit present in a spectrum obtained by ¹H-NMR measurement or ¹³C-NMR measurement.

The polyamide resin described above may be linear or branched. From the viewpoint of enhancing moldability and strength of a molded body, the polyamide resin described above is preferably linear. A linear polyamide resin can be obtained by using a polymerization initiator with one branching or two branching at the time of polymerization described below.

From the viewpoint of providing biodegradability, heat resistance and strength in water of a molded product in a compatible manner, the melting point of the polyamide resin described above is preferably 220° C. or lower, more preferably 160° C. or higher and 215° C. or lower, and even more preferably 190° C. or higher and 210° C. or lower. The melting point of the polyamide resin can be measured by a differential scanning calorimeter (DSC). Note that, when the difference Δ between degrees of randomness is large (i.e., when a block of any of the structural units is formed), two or more melting points may be observed for the polyamide resin by DSC. Because the polyamide resin of the present embodiment has a small difference Δ of degrees of randomness, only one melting point is observed in many cases.

Furthermore, the polyamide resin described above can have a large temperature difference between the melting point and the thermal decomposition temperature by containing the second monomer structural unit constituting the other polyamide structure. Since a homopolymer of polyamide 4 has the melting point and the thermal decomposition temperature that are close each other, melt molding is difficult; however, the polyamide described above can be easily melt-molded.

The weight average molecular weight (Mw) and the number average molecular weight (Mn) of the polyamide resin described above are not particularly limited. For example, from the viewpoint of enhancing strength and toughness of a molded product, the Mw of the polyamide resin described above is preferably 10,000 or greater, more preferably 30,000 or greater, and particularly preferably 50,000 or greater. From the viewpoint of enhancing processability during molding, the Mw of the polyamide resin described above is preferably 1,000,000 or less, more preferably 500,000 or less, even more preferably 300000 or less, yet even more preferably 200,000 or less, and particularly preferably 100,000 or less. The Mw of the polyamide resin described above can be determined by a known technology such as gel permeation chromatography (GPC), calibrated with a polymethyl methacrylate resin (PMMA).

The polydispersity (Mw/Mn) of the polyamide resin described above is preferably 3.0 or less, more preferably 2.5 or less, and even more preferably 2.0 or less. The lower limit value of the Mw/Mn is not particularly limited and can be 1.0 or greater. Because a smaller Mw/Mn results in less oligomers that are low molecular weight substances, change in properties due to elution of the oligomers at the time of use and environmental pollution due to the eluted oligomers can be suppressed. Furthermore, a smaller Mw/Mn can enhance mechanical strength of a molded body.

The polyamide resin described above can be synthesized by copolymerizing a monomer that becomes the first monomer structural unit represented by Formula (1) (first monomer) and a monomer that becomes the second monomer structural unit constituting the other polyamide structure (second monomer) in the presence of a basic catalyst and a polymerization initiator.

As the first monomer, glycine, α-alanine, β-alanine, β-lactam (2-azetidinone), and 2-pyrrolidone can be used. As the second monomer, a lactam compound having 5 or more and 12 or less carbons, such as δ-valerolactam (2-piperidone), ε-caprolactam, ω-octalactam, and ω-laurolactam, an amino acid, such as 6-aminohexanoic acid and 12-aminododecanoic acid, adipic acid and hexamethylenediamine, and a salt thereof and the like can be used.

The basic catalyst is only required to be a compound that can generate an anion species in each of the monomers. Examples of the basic catalyst include Grignard reagents, such as ethylmagnesium bromide (EtMgBr), ethylmagnesium chloride (EtMgCl), butylmagnesium chloride (BuMgCl), methylmagnesium chloride (MeMgCl), and methylmagnesium iodide (MeMgI); alkali metals, such as lithium, sodium, and potassium, and hydrides, oxides, hydroxides, carbonates, carboxylates, and alkylated bodies, and alkoxides thereof; and hydrides, oxides, hydroxides, carbonates, carboxylates, and alkylated bodies, and alkoxides of alkaline earth metals, such as calcium. Examples of the alkylated body of the alkali metal include tert-butoxy potassium. A potassium salt of 2-pyrrolidone may be allowed to act as a monomer and a basic catalyst. Among these, from the viewpoints of being less likely to cause environmental pollution by residue because the required amount is small, being able to be polymerized in a short period of time, achieving good yield, and easily achieving a smaller difference Δ between degrees of randomness by making the difference between reactivities of monomers smaller, a Grignard reagent is preferred.

The used amount (added amount) of the basic catalyst is not particularly limited and is preferably 0.01 mol % or greater and 20 mol % or less, more preferably 0.03 mol % or greater and 15 mol % or less, and even more preferably 0.05 mol % or greater and 10 mol % or less, with respect to the total amount of the raw material monomers. Note that, when the Grignard reagent is used, from the viewpoint of achieving good balance of the reaction rate and cost of the catalyst, the used amount of the basic catalyst can be 0.05 mol % or greater and 5 mol % or less, 0.1 mol % or greater and 2.5 mol % or less, and 1 mol % or greater and 1.5 mol % or less, with respect to the total amount of the raw material monomers.

Furthermore, as a catalytic promoter, a quaternary ammonium salt such as tetramethylammonium chloride, a quaternary phosphonium salt such as tetrabutylphosphonium bromide, a crown ether, and the like may be used in combination. By using these in combination, effects such as reduction in the catalyst amount, reduction in the polymerization time, and enhancement in yield can be expected.

Examples of the polymerization initiator include an ester compound or a derivative thereof, an imide compound, and carbon dioxide. From the viewpoint of enhancing moldability of the polyamide resin, an ester compound or a derivative thereof and an imide compound are preferred. The polymerization initiator may be a compound with one branching or may be a compound with two branching or three branching. From the viewpoint of providing improvement of processability at the time of molding and improvement of strength and toughness of the molded product, a compound with two branching is preferred, and a compound with one branching is more preferred. Examples of the polymerization initiator with one branching include tert-butyl acetate, isopropyl myristate, N-acetyl-ε-caprolactam, 1-acetyl-2-pyrrolidone, and N-benzoyl-2-pyrrolidone. Examples of the polymerization initiator having two branching or three branching include diisopropyl adipate and adipoyl dipyrrolidone.

The used amount (added amount) of the polymerization initiator is not particularly limited and is preferably 0.01 mol % or greater and 1.5 mol % or less, more preferably 0.03 mol % or greater and 1.0 mol % or less, even more preferably 0.05 mol % or greater and 0.75 mol % or less, and particularly preferably 0.2 mol % or greater and 0.3 mol % or less, with respect to the total amount of the raw material monomers. When the used amount of the polymerization initiator is in the range described above, a polyamide resin that has a high molecular weight can be obtained.

The polymerization temperature can be, for example, 25° C. or higher and 200° C. or lower. From the viewpoint of making a difference between reactivities of monomers small and making the difference Δ between degrees of randomness smaller, the polymerization temperature is preferably 50° C. or higher and 180° C. or lower, and more preferably 80° C. or higher and lower than 150° C.

Note that the synthesis method of the polyamide resin described above is not limited to this and, for example, γ-aminobutyric acid (GABA) and a lactam compound having 5 or more and 12 or less carbons or ω-amino carboxylic acid may be reacted.

### Polyamide Resin Composition and Molded Body

The polyamide resin described above can be formed into various shapes as a polyamide resin composition containing, as necessary, other additives.

Besides the polyamide resin described above, the polyamide resin composition described above may contain a known additive, such as another resin, a plasticizer, a nucleating agent, an antioxidant, a UV absorber, a dye, a pigment, a heat stabilizer, a light stabilizer, a filler (e.g., glass fiber), an internal mold release agent, a matting agent, an electroconductivity imparting agent, a charge control agent, an antistatic agent, a lubricant, and other processing aids.

Note that, from the viewpoint of enhancing biodegradability of a molded body, the polyamide resin composition described above has a proportion of the polyamide resin described above of preferably 30 mass % or greater and 100 mass % or less, more preferably 50 mass % or greater and 100 mass % or less, and even more preferably 90 mass % or greater and 100 mass % or less, with respect to the total mass of the resin component.

The method of molding is not particularly limited, and various molding methods such as injection molding, extrusion molding, press molding, and blow molding can be used. Furthermore, the molten polyamide resin composition may be spun and formed into a filament.

The form of the molded body obtained by molding is not particularly limited, and various forms such as a filament form, a film form, a particle form, and freely chosen three-dimensional shapes can be selected.

When the polyamide resin composition is melted and formed, the melting is preferably performed at a temperature that is higher than the melting point of the polyamide resin described above but lower than the thermal decomposition temperature. At this time, use of a resin having a low melting point as the polyamide resin described above expands the temperature range at which melt extrusion can be performed and can facilitate molding. For example, the melt extrusion can be performed at 170° C. or higher and 270° C. or lower.

The molded body obtained as described above has high strength on land and in water and also has good biodegradability.

For example, a knot strength of a molded body of the polyamide resin composition formed in a filament form measured at 25° C. and a humidity of 50%, for which moisture is adjusted to an equilibrium state at 25° C. and a relative humidity of 50%, can be 100 MPa or greater, and the knot strength is preferably 300 MPa or greater, and more preferably 600 MPa or greater. Furthermore, the filament described above can have a knot strength measured at 25° C. after immersed in pure water at 25° C. for 3 hours, taking out from the pure water and without drying can be 100 MPa or greater, and the knot strength is preferably 300 MPa or greater, and more preferably 500 MPa or greater. Furthermore, the filament form described above can have a knot strength measured at 25° C., after immersed in sea water at 25° C. for 3 hours, taking out from the sea water without drying can be 100 MPa or greater, and the knot strength is preferably 300 MPa or greater, and more preferably 500 MPa or greater. The upper limits of these knot strengths are not particularly limited and can be 1000 MPa or less.

Note that the knot strength described above is a value obtained by using a 300 mm long molded body in a filament form and having a half knot part at the center in the longitudinal direction as a test sample, setting a gripping distance to 150 mm and a crosshead speed of a test machine to 150 mm/min, and dividing an strength obtained at the break of the knot part by the diameter of the molded body in the filament form.

The sea water used in the measurement described above is required to have a NaCl concentration of 3% or greater and 4% or less. The sea water used in the measurement described above may be sea water actually sampled from the sea or may be a commercially available artificial sea water, such as MARINE ART (trade name) SF-1, available from Osaka Yakken Co., Ltd.

Furthermore, the molded body in the filament form described above has a reduction percentage of a knot strength measured at 25° C. and a relative humidity of 50% after the molded body is knotted, then stored at an interface between sea water and sediment at 25° C. for 1 month, and then dried by stored in a dry room at 25° C. with a dew point of −40° C. or lower for 3 days, with respect to the knot strength described above measured at 25° C. and a relative humidity of 50% of preferably 10% or greater, more preferably 20% or greater, and even more preferably 30% or greater. Meanwhile, from the viewpoint of suppressing reduction in strength during use of the molded body in the filament form in sea water, the reduction percentage described above is preferably 80% or less, more preferably 70% or less, and even more preferably 60% or less.

Note that the interface between the sea water and the sediment described above means an environment that is stipulated in ISO 19679 and that is within 5 cm from the interface between the sea water and the sediment. The sediment described above can be sea sand sampled from the sea.

### Use

The molded body of the polyamide resin composition described above can be used in various use, such as a fishing line, a fishing net, a film for agriculture, a fiber for clothing and woven fabric made thereof, a cosmetic product, a coating, a functional particle such as an anti-blocking agent, a film for packaging, a food container, tableware, and household goods such as a razor and a toothbrush.

### OTHER EMBODIMENTS

Note that the above-described embodiment is an exemplary embodiment of the present invention, and it is needless to say that the present invention can include embodiments other than the above-described embodiment within the scope of the core technical idea thereof.

### EXAMPLES

The present invention will be described in detail below based on examples, but the present invention is not limited to these examples.

### 1. Preparation of Filament for Testing

Polymers 1 to 6, a polymer 8, and a polymer 9 were synthesized by the following method. Using these and a polymer 7, a filament 1 for testing to a filament 9 for testing were prepared by the following method.

### 1-1. Preparation of Filament 1 for Testing

243.8 g (2.86 mol) of 2-pyrrolidone, available from Mitsubishi Chemical Corporation, and 756.2 g (6.68 mol) of ε-caprolactam, available from Tokyo Chemical Industry Co., Ltd., were prepared, mixed, and heated and melted at 80° C., and thus a uniform monomer solution was prepared. This monomer solution was divided into two. In one of the monomer solutions, 8.03 g (0.30 mol % with respect to the total moles of the 2-pyrrolidone and the ε-caprolactam) of adipoyl dipyrrolidone separately synthesized was added and dissolved, and thus an initiator solution was obtained. In the other monomer solution, 143.2 mL (1.5 mol % of ethylmagnesium bromide (EtMgBr) with respect to the total moles of the 2-pyrrolidone and the ε-caprolactam) of a tetrahydrofuran solution of EtMgBr, available from Tokyo Chemical Industry Co., Ltd., (approximately 1 mol/L) was added dropwise, then tetrahydrofuran was distilled off and removed under reduced pressure, and thus a catalyst solution was obtained. The initiator solution and the catalyst solution were mixed and polymerization-reacted at 100° C., and thus a polymer 1 was obtained.

After the polymer was crushed, the polymer was washed with pure water, an acetic acid aqueous solution, pure water, and pure water in this order, and unreacted monomers and the catalyst were removed. Thereafter, water was removed by drying under reduced pressure, and thus a polymer powder for spinning was obtained.

The obtained polymer powder described above was fed to a small twin-screw extruder, melt-extruded into a fibrous form, and cooled and solidified by passing through a cold bath, and thus an unstretched monofilament was produced. This monofilament was appropriately stretched, and thus a filament 1 for testing was obtained.

### 1-2. Preparation of Filament 2 for Testing

A polymer 2 was obtained in the same manner as in the synthesis of the polymer 1 except for changing the raw materials of the polymer to 1.38 mol of 2-pyrrolidone and 7.80 mol of ε-caprolactam. Using this polymer 2, a monofilament was prepared in the same manner as in preparation of the filament 1 for testing. The monofilament was then stretched, and thus a filament 2 for testing was prepared.

### 1-3. Preparation of Filament 3 for Testing

A polymer 3 was obtained in the same manner as in the synthesis of the polymer 1 except for changing the raw materials of the polymer to 1.86 mol of 2-pyrrolidone and 7.44 mol of ε-caprolactam, and blending 0.30 mol % of isopropyl myristate with respect to the total moles of the 2-pyrrolidone and the ε-caprolactam in place of the adipoyl dipyrrolidone as the initiator. Using this polymer 3, a monofilament was prepared in the same manner as in preparation of the filament 1 for testing. The monofilament was then stretched, and thus a filament 3 for testing was prepared.

### 1-4. Preparation of Filament 4 for Testing

A polymer 4 was obtained in the same manner as in the synthesis of the polymer 1 except for changing the raw materials of the polymer to 4.03 mol of 2-pyrrolidone and 4.03 mol of ε-caprolactam, blending 0.20 mol % of N-acetyl-ε-caprolactam with respect to the total moles of the 2-pyrrolidone and the ε-caprolactam in place of the adipoyl dipyrrolidone as the initiator blended in the initiator solution, changing the blended amount of the EtMgBr blended in the catalyst solution to 1.0 mol % with respect to the total moles of the 2-pyrrolidone and the ε-caprolactam, and changing the temperature of the polymerization reaction to 60° C. Using this polymer 4, a monofilament was prepared in the same manner as in preparation of the filament 1 for testing. The monofilament was then stretched, and thus a filament 4 for testing was prepared.

### 1-5. Preparation of Filament 5 for Testing

A polymer 5 was obtained in the same manner as in the synthesis of the polymer 1 except for changing the raw materials of the polymer to 4.03 mol of 2-pyrrolidone and 4.03 mol of ε-caprolactam, blending 0.20 mol % of N-acetyl-ε-caprolactam with respect to the total moles of the 2-pyrrolidone and the ε-caprolactam in place of the adipoyl dipyrrolidone as the initiator blended in the initiator solution, changing the blended amount of the EtMgBr blended in the catalyst solution to 1.0 mol % with respect to the total moles of the 2-pyrrolidone and the ε-caprolactam, and changing the temperature of the polymerization reaction to 50° C. Using this polymer 5, a monofilament was prepared in the same manner as in preparation of the filament 1 for testing. The monofilament was then stretched, and thus a filament 5 for testing was prepared. 1-6. Preparation of Filament 6 for Testing

A polymer 6 was obtained in the same manner as in the synthesis of the polymer 1 except for changing the raw materials of the polymer to 141.00 mol of 2-pyrrolidone and 0.00 mol of ε-caprolactam, blending 0.10 mol % of tert-butyl acetate with respect to the total moles of the 2-pyrrolidone and the ε-caprolactam in place of the adipoyl dipyrrolidone as the initiator blended in the initiator solution, blending 2.0 mol % each of tert-butoxy potassium (tBuOK) and tetramethylammonium chloride (TMAC) with respect to the total moles of the 2-pyrrolidone and the ε-caprolactam in place of the EtMgBr as the catalyst blended in the catalyst solution, and changing the temperature of the polymerization reaction to 25° C. Using this polymer 6, a monofilament was prepared in the same manner as in preparation of the filament 1 for testing. The monofilament was then stretched, and thus a filament 6 for testing was prepared.

### 1-7. Preparation of Filament 7 for Testing

A commercially available polyamide 6 resin (UBE nylon 1022B, available from Ube Industries, Ltd.) was used as a polymer 7. This polymer 7 was pulverized to obtain a polymer powder for spinning. Using the obtained polymer powder described above, a monofilament was prepared in the same manner as in the preparation of the filament 1 for testing. This monofilament was appropriately stretched, and thus a filament 7 for testing was obtained.

### 1-8. Preparation of Filament 8 for Testing

A polymer 8 was obtained in the same manner as in the synthesis of the polymer 1 except for changing the raw materials of the polymer to 0.95 mol of 2-pyrrolidone and 1.93 mol of ε-caprolactam. Using this polymer 8, a monofilament was prepared in the same manner as in preparation of the filament 1 for testing. The monofilament was then stretched, and thus a filament 8 for testing was prepared.

### 1-9. Preparation of Filament 9 for Testing

A polymer 9 was obtained in the same manner as in the synthesis of the polymer 1 except for changing the raw materials of the polymer to 1.24 mol of 2-pyrrolidone and 1.72 mol of ε-caprolactam. Using this polymer 9, a monofilament was prepared in the same manner as in preparation of the filament 1 for testing. The monofilament was then stretched, and thus a filament 12 for testing was prepared.

The polymerization conditions for the polymer 1 to the polymer 9 used in the production of the filament 1 for testing to the filament 9 for testing and the stretching ratio of the filament 1 for testing to the filament 9 for testing are listed in Table 1. Note that, regarding the type of the polymer, “PA 4/6” refers to polyamide 4/6, “PA 4” refers to polyamide 4, and “PA 6” refers to polyamide 6. The added amounts of the initiator and the catalyst are blended amounts with respect to the total moles of the monomers, “pyrrolidone” in the monomer refers to the amount of 2-pyrrolidone, and “caprolactam” refers to the amount of ε-caprolactam.

TABLE 1

| | | Initiator | | Catalyst | | Monomer | | | |
|---|---|---|---|---|---|---|---|---|---|
| | | | Added | | Added | Pyrrol- | Capro- | Polymerization | |
| Polymer | | | amount | | amount | idone | lactam | temperature | Stretching |
| No. | Type | Type | (mol %) | Type | (mol %) | (mol) | (mol) | (° C.) | ratio |
| 1 | PA 4/6 | Adipoyl | 0.30 | EtMgBr | 1.5 | 2.86 | 6.68 | 100 | 6 |
| | | dipyrrolidone | | | | | | | |
| | | (two branching) | | | | | | | |
| 2 | PA 4/6 | Adipoyl | 0.30 | EtMgBr | 1.5 | 1.38 | 7.80 | 100 | 5.5 |
| | | dipyrrolidone | | | | | | | |
| | | (two branching) | | | | | | | |
| 3 | PA 4/6 | Isopropy | 0.30 | EtMgBr | 1.5 | 1.86 | 7.44 | 100 | 5.5 |
| | | l myristate | | | | | | | |
| | | (one branching) | | | | | | | |
| 4 | PA 4/6 | Acetylcapro- | 0.20 | EtMgBr | 1.0 | 4.03 | 4.03 | 60 | 6 |
| | | lactam | | | | | | | |
| | | (one branching) | | | | | | | |
| 5 | PA 4/6 | Acetylcapro- | 0.20 | EtMgBr | 1.0 | 4.03 | 4.03 | 50 | 6 |
| | | lactam | | | | | | | |
| | | (one branching) | | | | | | | |
| 6 | PA 4 | tert-Butyl | 0.10 | tBuOK | 2.0 | 141.00 | — | 25 | 4.5 |
| | | acetate | | TMAC | 2.0 | | | | |
| | | (one branching) | | | | | | | |
| 7 | PA 6 | — | — | — | — | — | — | — | 5.4 |
| 8 | PA 4/6 | Adipoyl | 0.30 | EtMgBr | 1.5 | 0.95 | 1.93 | 100 | 5.5 |
| | | dipyrrolidone | | | | | | | |
| | | (two branching) | | | | | | | |
| 9 | PA 4/6 | Adipoyl | 0.30 | EtMgBr | 1.5 | 1.24 | 1.72 | 100 | 5.5 |
| | | dipyrrolidone | | | | | | | |
| | | (two branching) | | | | | | | |

### 2. Measurement

For the polymer 1 to the polymer 9, measurement using ¹H-NMR, ¹³C-NMR, DSC, and TGA, yield calculation, and biodegradability (based on O₂) test were performed by the following methods. GPC analysis was performed for the filament 1 for testing to the filament 9 for testing by the following method.

### 2-1. ¹H-NMR Measurement

¹H-NMR spectrum was obtained by using a nuclear magnetic resonance spectrometer (JNM-ECZ600R/S1, available from JASCO Corporation). Specifically, 10 mg of a sample of each of the polymers was dissolved in 1 mL of a mixed solvent having a volume ratio of trifluoroethanol (TFE)/deuterated chloroform (CDCl₃) of 1/1. Then, measurement was performed using tetramethylsilane (TMS) as a reference. Among peak integrated values originated from methylene groups appearing from 1.0 ppm to 2.0 ppm in the obtained spectrum, a ratio of an integrated value of a peak of methylene proton originated from the PA 4 structural unit and an integrated value of a peak of methylene proton originated from the PA 6 unit was determined. From the integrated value ratio of these peaks, the proportion of the PA 4 structural unit was calculated, and this was used as “PA 4 proportion”.

Furthermore, based on this PA 4 proportion and the proportion of the PA 6 structural unit (PA 6 proportion) calculated simultaneously, the degree of randomness ((PA 4 proportion)×(PA 6 proportion)×2) assuming that each of the polymers had an ideal random sequence of the PA 4 structural unit and the PA 6 structural unit was calculated, and this was used as “theoretical degree of ¹H randomness”.

### 2-2. ¹³C-NMR Measurement

¹³C-NMR spectrum was obtained by using a nuclear magnetic resonance spectrometer (JNM-ECZ600R/S1, available from JASCO Corporation). Specifically, 10 mg of a sample of each of the polymers was dissolved in 1 mL of a mixed solvent having a volume ratio of trifluoroethanol (TFE)/deuterated chloroform (CDCl₃) of 1/1. Then, measurement was performed using tetramethylsilane (TMS) as a reference. The proportion of peak integrated value of carbonyl carbon of an amide group linking the PA 4 structural unit and the PA 6 structural unit with respect to the total of all peak integrated values originated from carbonyl carbons appearing from 174 ppm to 177 ppm in the obtained spectrum was calculated, and this was used as “degree of ¹³C randomness”.

### 2-3. DSC Measurement

A DSC curve was obtained by the differential scanning calorimetry method (DSC method) using a differential scanning calorimeter (DSC3⁺, available from Mettler-Toledo). Specifically, 10 mg of a sample of each of the polymers was weighed in an aluminum pan, and the temperature was increased at a rate of 20° C./minute in a range of 25° C. to 280° C. in a nitrogen atmosphere, and thus a DSC curve was obtained. A peak temperature of an endothermic peak of melting behavior in this DSC curve was used as “melting point” of each of the polymers.

### 2-4. TGA Measurement

A thermogravimetric reduction curve was obtained by using a simultaneous thermogravimetry-differential scanning calorimeter (TGA/DSC 2, available from Mettler-Toledo). Specifically, 10 mg of a sample of each of the polymers was weighed in an aluminum pan, and the temperature was increased at a rate of 20° C./minute in a range of 25° C. to 500° C. in a nitrogen atmosphere, and thus a thermogravimetric reduction curve was obtained. The temperature at which weight was reduced by 5% in this thermogravimetric reduction curve was used as “5% thermogravimetric reduction temperature” of each of the polymers.

### 2-5. GPC Analysis

GPC analysis was performed by using a gel permeation chromatography (GPC) analysis device (HLC-8420GPC, available from Tosoh Corporation). Specifically, 10 mg of a sample of each of the filaments for testing was dissolved in hexafluoroisopropanol (HFIP), in which sodium trifluoroacetate had been dissolved at a concentration of 5 mM, to prepare 10 mL of a solution. The solution was then filtered using a membrane filter, and thus a sample solution was obtained. In the analysis device, 100 μL of this sample solution was injected, and measurement was performed in the following conditions. From the chromatogram obtained by the measurement, the weight average molecular weight (Mw) and the number average molecular weight (Mn) of the polymer constituting each of the filaments for testing were calculated using a calibration curve obtained by a poly(methyl methacrylate) resin (PMMA) having a known molecular weight.
Instrument: HLC-8420 GPC, available from Tosoh Corporation
Column: HFIP 806M×2 in series, 40° C.
Eluent: 5 mM CF₃COONa/HFIP
Flow rate: 1.0 mL/min
Detector: Differential refractometer (RI)

### 2-6. Yield

The yield was a ratio of a weight of a polymer recovered after being water-washed for 5 times and dried after completion of the polymerization and a weight before the water washing.

### 2-7. Biodegradability (Based on O₂)

In 4000 ml of sea water sampled from Pacific Ocean coastline, 2000 g of sediment sampled similarly from Pacific Ocean coastline was added and subjected to an ultrasonic treatment to extract microorganisms from the sediment into the sea water. In the extracted sea water, 0.5 g/L of ammonium chloride and 0.1 g/L of potassium dihydrogenphosphate as nutritive salts were dissolved and then subjected to an aeration treatment, and thus extracted sea water was prepared. In 300 ml of the prepared extracted sea water, approximately 40 mg of the polymer powder was dispersed. The pressure change caused by allowing sodium hydroxide to capture generated carbon dioxide in a tightly sealed environment was measured for 4 weeks using a BOD meter (OxiTop i, available from WTW). The biodegradability of the polymer powder was evaluated based on the following equation using the oxygen amount required in a case where the polymer was 100% decomposed as a theoretical value.

Biodegradability (%)=(amount of oxygen consumption originated from sample/theoretical amount of oxygen requirement)×100

In Table 2 and Table 3, the PA 4 proportion, the yield, the theoretical degree of ¹H randomness, the degree of ¹³C randomness, the difference Δ between the theoretical degree of ¹H randomness and the degree of ¹³C randomness, the melting point, the 5% thermogravimetric reduction temperature, the difference ΔT between the melting point and the 5% thermogravimetric reduction temperature, the weight average molecular weight Mw, the number average molecular weight Mn, the Mw/Mn, the PA 4 proportion of each of the polymers in terms of mass calculated based on the molar ratio of the PA 4, and the biodegradability (based on O₂) of the polymer 1 to the polymer 9 and the filament 1 for testing to the filament 9 for testing are listed.

TABLE 2

| Polymer | | | | | Difference |
|---|---|---|---|---|---|
| No./ | PA 4 | Yield | Theoretical | Degree | Δ between |
| Filament | proportion | (wt. | degree of ¹H | of ¹³C | degrees of |
| No. | (mol %) | %) | randomness | randomness | randomness |
| 1 | 13 | 81 | 0.23 | 0.22 | 0.01 |
| 2 | 7 | 59 | 0.13 | 0.10 | 0.03 |
| 3 | 10 | 46 | 0.18 | 0.12 | 0.06 |
| 4 | 33 | 52 | 0.44 | 0.44 | 0.00 |
| 5 | 39 | 60 | 0.48 | 0.48 | 0.00 |
| 6 | 100 | 75 | 0.00 | 0.00 | 0.00 |
| 7 | 0 | — | 0.00 | 0.00 | 0.00 |
| 8 | 15 | 79 | 0.26 | 0.26 | 0.00 |
| 9 | 20 | 74 | 0.32 | 0.32 | 0.00 |

TABLE 3

| Polymer | Melting | 5% Weight | | | | | PA 4 | Biodegradability |
|---|---|---|---|---|---|---|---|---|
| No./Filament | point | reduction | ΔT | Mw | Mn | | proportion | (based on O₂) |
| No. | (° C.) | temperature | (° C.) | (10⁴ g/mol) | (10⁴ g/mol) | Mw/Mn | (wt %) | (%) |
| 1 | 197 | 362 | 165 | 5.8 | 3.6 | 1.6 | 10 | 71 |
| 2 | 206 | 395 | 189 | 5.9 | 3.0 | 2.0 | 5 | 25 |
| 3 | 206 | — | — | 3.8 | 1.9 | 2.0 | 8 | >95 |
| 4 | 170 | — | — | 6.7 | 3.6 | 1.9 | 27 | >95 |
| 5 | 163 | — | — | 9.3 | 4.7 | 2.0 | 32 | >95 |
| 6 | 265 | 306 | 41 | 11.8 | 7.0 | 1.7 | 100 | >95 |
| 7 | 225 | 422 | 197 | 6.1 | 3.6 | 1.7 | 0 | <1 |
| 8 | 195 | — | — | 6.5 | 3.8 | 1.7 | 12 | >95 |
| 9 | 185 | — | — | 5.0 | 3.2 | 1.6 | 16 | >95 |

### 3. Evaluation

### 3-1. Strength

Knot strength of each of the filament 1 for testing to the filament 9 for testing and the polymer 1 to the polymer 9 in an indoor environment, an underwater environment, and a biodegradable environment was measured by the following method.

The knot strength was measured in an indoor environment, an underwater environment, and a biodegradable environment using a tensile test machine (TENSILON RTF-1210, available from A&D Company, Limited). Specifically, the knot strength in each environment was a value obtained by using each of the 300 mm long filaments for testing having a half knot part at the center in the longitudinal direction as a test sample, setting a gripping distance to 150 mm and a crosshead speed of the test machine to 150 mm/min, and dividing a load at the break of the knot part by the diameter of the filament for testing.

The conditions of the environment are as follows.
Indoor environment: Knotted at 25° C. and a relative humidity of 50% and then measured
Underwater environment: Immersed in pure water at 25° C. for 3 hours, then knotted at 25° C. and a relative humidity of 50% without being dried, and then measured
Biodegradable environment: Stored at an interface between sea water and sediment at 25° C. for 1 month, then stored in a dry room at 25° C. with a dew point of −40° C. or lower for 3 days to be dried, then knotted at 25° C. and a relative humidity of 50%, and then measured
Note that, as the sea water and the sediment, sea water sampled from Pacific Ocean coastline (NaCl concentration: 3.1 to 3.4%) and sea sand were respectively used.

Furthermore, the difference between the knot strength in the indoor environment and the knot strength in the biodegradable environment was calculated. Then, the proportion of this difference with respect to the knot strength in the indoor environment ((knot strength in indoor environment-knot strength in biodegradable environment)/knot strength in indoor environment x 100) was determined and used as “reduction percentage of strength after biodegradation”. A case where the reduction percentage of strength in the biodegradable environment was 10% or greater was judged as having “biodegradability (based on strength)”.

### 3-2. First Monomer Content

Approximately 100 mg of a sample was dissolved in 10 mL of HFIP, and then acetone was added to attain 50 ml of a liquid. Thereafter, a filtrate obtained by removing the precipitated polymer by a 20-μm membrane filter was measured.
Measurement instrument: GC-2010 Plus, available Shimadzu Corporation
Column: Rix 15 MS (0.25 mm φ—15 m-0.25 μm df), available from RESTEK
Column temperature: 50° C.-5 min→(20° C./min)→250° C.
Vaporization chamber temperature: 250° C.
Detector: FID
Split ratio: 50
Injection amount: 1 μL
Make up gas: He
Gas flow rate: 30 mL/min

The evaluation results of the knot strength in each of the indoor environment, the underwater environment, and the biodegradable environment, the reduction percentage of strength after biodegradation, and the biodegradability evaluated based on the reduction percentage of strength, and the content of 2-pyrrolidone of the filament 1 for testing to the filament 9 for testing are listed in Table 4.

TABLE 4

| | | | | | Reduction | | |
|---|---|---|---|---|---|---|---|
| | | Knot strength (MPa) | | | percentage of | Biodegrad- | First |
| | | Indoor | Underwater | Biodegradable | strength after | ability | monomer |
| | Filament | environ- | environ- | environ- | biodegradation | (based on | content |
| Notes | No. | ment | ment | ment | (%) | strength) | (wt %) |
| Examples | 1 | 791 | 598 | 363 | 54 | Yes | Not detected |
| Examples | 2 | 672 | 651 | 324 | 52 | Yes | Not detected |
| Examples | 3 | 577 | 418 | 340 | 41 | Yes | Not detected |
| Examples | 4 | 659 | 181 | 260 | 61 | Yes | Not detected |
| Examples | 5 | 599 | 153 | 176 | 71 | Yes | Not detected |
| Reference | 6 | 700 | 461 | 187 | 73 | Yes | 3.8 |
| Example | | | | | | | |
| Comparative | 7 | 595 | 591 | 545 | 8 | No | Not detected |
| Examples | | | | | | | |
| Examples | 8 | 538 | 390 | 370 | 31 | Yes | Not detected |
| Examples | 9 | 522 | 309 | 317 | 41 | Yes | Not detected |

As is clear from Table 1 to Table 4, the polymer 1 to the polymer 5, the polymer 8, and the polymer 9 that were the polyamide resins each having the difference Δ between degrees of randomness of 0.10 or less exhibited high biodegradability evaluated based on O₂ than those of PA 4 proportion, in terms of mass, of each of the polymers, and biodegraded equal to or more than the proportion of the PA 4.

This application claims priority from the Japanese Patent Application No. 2022-158909 filed on Sep. 30, 2022, and the Japanese Patent Application No. 2023-074569 filed on Apr. 28, 2023. The original specification of the application, and the matters described in the claims are hereby incorporated by reference into the present application.

### INDUSTRIAL APPLICABILITY

The polyamide resin related to an embodiment of the present invention can produce a molded body having high strength and biodegradability. The polyamide resin of an embodiment of the present invention can be applied for various uses and is expected to contribute to reduction in environmental pollution caused by waste plastics.

1. A polyamide resin, comprising: a first monomer structural unit represented by Formula (1) and a second monomer structural unit constituting another polyamide structure,
wherein a difference between a degree of randomness that is determined based on proportions of the first monomer structural unit and the second monomer structural unit as determined by ¹H-NMR measurement when the first monomer structural unit is assumed to have an ideal random sequence and a degree of randomness that is determined based on a proportion of carbonyl carbon of an amide group linking the first monomer structural unit and the second monomer structural unit with respect to a total peak integrated value for carbonyl carbon as determined by ¹³C-NMR measurement is 0.10 or less, 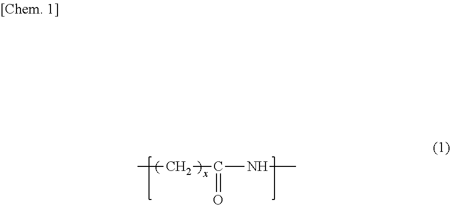
where in Formula (1), x is an integer of 1 or greater and 3 or less.

2. The polyamide resin according to claim 1, wherein
a proportion of the first monomer structural unit represented by Formula (1) with respect to all structural units is 1 mol % or greater and less than 40 mol %.

3-9. (canceled)

10. The polyamide resin according to claim 1, wherein
the first monomer structural unit represented by Formula (1) comprises a structural unit where x is 3.

11. The polyamide resin according to claim 2, wherein
the first monomer structural unit represented by Formula (1) comprises a structural unit where x is 3.

12. The polyamide resin according to claim 1, wherein
the second monomer structural unit constituting the other polyamide structure includes a polyamide 6 structural unit.

13. The polyamide resin according to claim 10, wherein
the second monomer structural unit constituting the other polyamide structure includes a polyamide 6 structural unit.

14. The polyamide resin according to claim 11, wherein
the second monomer structural unit constituting the other polyamide structure includes a polyamide 6 structural unit.

15. A polyamide resin composition comprising the polyamide resin described in claim 1.

16. A polyamide resin composition comprising the polyamide resin described in claim 10.

17. A molded body obtained by molding the polyamide resin composition described in claim 16.

18. The molded body according to claim 17, which is a filament.

19. A method for producing a polyamide resin, the method comprising:
preparing, by polymerization, a first monomer constituting a structural unit represented by Formula (1) and a second monomer constituting another polyamide structural unit, and
polymerizing the first monomer and the second monomer in the presence of a Grignard reagent and a polymerization initiator, 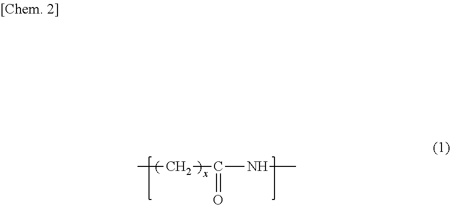
where in Formula (1), x is an integer of 1 or greater and 3 or less.

20. The method for producing a polyamide resin according to claim 19, wherein the polymerizing is performed at 50° C. or higher.
